(19) United States
(12) Patent Application Publication
(10) Pub. No.: US 2020/0107283 A1
(43) Pub. Date: Apr. 2, 2020

(54) TIMING ADVANCE VALIDATION AND UPDATE PROCEDURES ASSOCIATED WITH UPLINK TRANSMISSION OVER PRECONFIGURED RESOURCES

(71) Applicant: Nokia Technologies Oy, Espoo (FI)

(72) Inventors: Rapeepat RATASUK, Hoffman Estates, IL (US); David BHATOOLAUL, Swindon (GB); Srinivasan SELVAGANAPATHY, Bangalore (IN)

(21) Appl. No.: 16/574,624

(22) Filed: Sep. 18, 2019

(30) Foreign Application Priority Data
Sep. 28, 2018 (IN) 201841036667

(51) Int. Cl. H04W 56/00; H04W 72/04; H04W 76/27; H04L 27/26

(52) U.S. Cl. CPC H04W 56/005; H04W 72/0493; H04L 27/2607; H04W 76/27; H04W 72/042

(57) ABSTRACT

Various communication systems may benefit from uplink transmission over preconfigured resources. In accordance with some embodiments, an apparatus may comprise at least one memory comprising computer program code and at least one processor. The at least one memory and the computer program code are configured, with the at least one processor, to cause the apparatus at least to receive at least one indication of at least one resource from a network entity. The apparatus may further determine whether at least one current timing advance value is valid. The apparatus may further, upon determining that the at least one current timing advance value is not valid, performing at least one timing advance update procedure. At least one timing advance update procedure is performed when at least one estimated timing advance shift is within at least one threshold.

### CROSS REFERENCE TO RELATED APPLICATIONS

This application claims priority from Indian Provisional Application No. 201841036667, filed on Sep. 28, 2018. The entire contents of this earlier filed application are hereby incorporated by reference in their entirety.

### BACKGROUND

### Field

Various communication systems may benefit from uplink transmission over preconfigured resources. For example, certain communication systems may benefit from pre-configured grant transmissions.

### Description of the Related Art

The pre-requisite for user equipment to send small data over preconfigured resources is the possession of a valid timing advance. The eNB attempts to decode the NPUSCH/PUSCH associated with the preconfigured resources using the CP corresponding to a connected mode, which assumes that a UE uplink is time synchronized prior to the transmission. When preconfigured resources are assigned to a UE in idle mode, the UE may need to check whether the latest timing advance assigned is still valid at the time of uplink transmission over the preconfigured resource. In case the UE determines that its timing advance is not valid, the UE needs to first obtain a valid timing advance value via some mechanism.

### SUMMARY

In accordance with some embodiments, a method may include receiving at least one indication of at least one resource from a network entity. The method may further include determining whether at least one current timing advance value is valid. The method may further include, upon determining that the at least one current timing advance value is not valid, performing at least one timing advance validation procedure. At least one timing advance update procedure is performed when at least one estimated timing advance shift is within at least one threshold, and at least one legacy timing advance procedure is performed when at least one estimated timing advance shift is not within at least one threshold.

In accordance with some embodiments, an apparatus may include means for receiving at least one indication of at least one resource from a network entity. The apparatus may further include means for determining whether at least one current timing advance value is valid. The apparatus may further include means for, upon determining that the at least one current timing advance value is not valid, performing at least one timing advance validation procedure. At least one timing advance update procedure is performed when at least one estimated timing advance shift is within at least one threshold, and at least one legacy timing advance procedure is performed when at least one estimated timing advance shift is not within at least one threshold.

In accordance with some embodiments, an apparatus may include at least one processor and at least one memory including computer program code. The at least one memory and the computer program code can be configured to, with the at least one processor, cause the apparatus to at least receive at least one indication of at least one resource from a network entity. The at least one memory and the computer program code can be further configured to, with the at least one processor, cause the apparatus to at least determine whether at least one current timing advance value is valid. The at least one memory and the computer program code can be further configured to, with the at least one processor, cause the apparatus to at least, upon determining that the at least one current timing advance value is not valid, perform at least one timing advance validation procedure. At least one timing advance update procedure is performed when at least one estimated timing advance shift is within at least one threshold, and at least one legacy timing advance procedure is performed when at least one estimated timing advance shift is not within at least one threshold.

In accordance with some embodiments, a non-transitory computer readable medium can be encoded with instructions that may, when executed in hardware, perform a method. The method may receive at least one indication of at least one resource from a network entity. The method may further determine whether at least one current timing advance value is valid. The method may further, upon determining that the at least one current timing advance value is not valid, performing at least one timing advance validation procedure. At least one timing advance update procedure is performed when at least one estimated timing advance shift is within at least one threshold, and at least one legacy timing advance procedure is performed when at least one estimated timing advance shift is not within at least one threshold.

In accordance with some embodiments, a computer program product may perform a method. The method may receive at least one indication of at least one resource from a network entity. The method may further determine whether at least one current timing advance value is valid. The method may further, upon determining that the at least one current timing advance value is not valid, performing at least one timing advance validation procedure. At least one timing advance update procedure is performed when at least one estimated timing advance shift is within at least one threshold, and at least one legacy timing advance procedure is performed when at least one estimated timing advance shift is not within at least one threshold.

In accordance with some embodiments, an apparatus may include circuitry configured to receive at least one indication of at least one resource from a network entity. The circuitry may be further configured to determine whether at least one current timing advance value is valid. The circuitry may be further configured to, upon determining that the at least one current timing advance value is not valid, perform at least one timing advance validation procedure. At least one timing advance update procedure is performed when at least one estimated timing advance shift is within at least one threshold, and at least one legacy timing advance procedure is performed when at least one estimated timing advance shift is not within at least one threshold.

In accordance with some embodiments, a method may include determining whether to assign at least one preconfigured resource to a user equipment. The method may further include upon determining to assign at least one preconfigured resource to the user equipment, transmitting at least one indication of at least one resource to the user equipment. The method may further include transmitting at least one timing advance to the user equipment corresponding to an additional TA shift or adjustment with at least one reference to at least one previous TA value.

In accordance with some embodiments, an apparatus may include means for determining whether to assign at least one preconfigured resource to a user equipment. The apparatus may further include means for upon determining to assign at least one preconfigured resource to the user equipment, transmitting at least one indication of at least one resource to the user equipment. The apparatus may further include means for transmitting at least one timing advance to the user equipment corresponding to an additional TA shift or adjustment with at least one reference to at least one previous TA value.

In accordance with some embodiments, an apparatus may include at least one processor and at least one memory including computer program code. The at least one memory and the computer program code can be configured to, with the at least one processor, cause the apparatus to at least determine whether to assign at least one preconfigured resource to a user equipment. The at least one memory and the computer program code can be further configured to, with the at least one processor, cause the apparatus to at least upon determining to assign at least one preconfigured resource to the user equipment, transmit at least one indication of at least one resource to the user equipment. The at least one memory and the computer program code can be further configured to, with the at least one processor, cause the apparatus to at least transmit at least one timing advance to the user equipment corresponding to an additional TA shift or adjustment with at least one reference to at least one previous TA value.

In accordance with some embodiments, a non-transitory computer readable medium can be encoded with instructions that may, when executed in hardware, perform a method. The method may determine whether to assign at least one preconfigured resource to a user equipment. The method may further, upon determining to assign at least one preconfigured resource to the user equipment, transmit at least one indication of at least one resource to the user equipment. The method may further transmit at least one timing advance to the user equipment corresponding to an additional TA shift or adjustment with at least one reference to at least one previous TA value.

In accordance with some embodiments, a computer program product may perform a method. The method may determine whether to assign at least one preconfigured resource to a user equipment. The method may further upon determining to assign at least one preconfigured resource to the user equipment, transmit at least one indication of at least one resource to the user equipment. The method may further transmit at least one timing advance to the user equipment corresponding to an additional TA shift or adjustment with at least one reference to at least one previous TA value.

In accordance with some embodiments, an apparatus may include circuitry configured to determine whether to assign at least one preconfigured resource to a user equipment. The circuitry may be further configured to upon determining to assign at least one preconfigured resource to the user equipment, transmit at least one indication of at least one resource to the user equipment. The circuitry may be further configured to transmit at least one timing advance to the user equipment corresponding to an additional TA shift or adjustment with at least one reference to at least one previous TA value.

### BRIEF DESCRIPTION OF THE DRAWINGS

For proper understanding of the invention, reference should be made to the accompanying drawings, wherein:

FIG. 1 illustrates a signaling diagram according to certain embodiments.

FIG. 2 illustrates an example of a method performed by a user equipment according to certain embodiments.

FIG. 3 illustrates an example of a method performed by a network entity according to certain embodiments.

FIG. 4 illustrates an example of a system according to certain embodiments.

### SUMMARY

In a first aspect thereof the exemplary embodiments of this invention provide a method that comprises receiving at least one indication of at least one resource from a network entity for uplink transmission; determining whether at least one current timing advance value is valid; and performing at least one timing advance update procedure upon determining that the at least one current timing advance value is not valid.

In a further aspect thereof the exemplary embodiments of this invention provide an apparatus that comprises at least one data processor and at least one memory that includes computer program code. The at least one memory and computer program code are configured, with the at least one data processor, to cause the apparatus, at least to receive at least one indication of at least one resource from a network entity for uplink transmission; determine whether at least one current timing advance value is valid; and

perform at least one timing advance update procedure upon determining that the at least one current timing advance value is not valid.

In another aspect thereof the exemplary embodiments of this invention provide an apparatus that comprises at least one data processor and at least one memory that includes computer program code. The at least one memory and computer program code are configured, with the at least one data processor, to cause the apparatus, at least to determine whether to assign at least one preconfigured resource to a user equipment;

transmit at least one indication of at least one resource to the user equipment upon determining to assign at least one preconfigured resource to the user equipment; and
transmit at least one timing advance to the user equipment corresponding to an additional timing advance shift or adjustment with at least one reference to at least one previous timing advance value.

### DETAILED DESCRIPTION

Certain embodiments discussed herein may enable user equipment to check whether an assigned timing advance is still valid at the time of uplink transmissions over the preconfigured resource. Certain embodiments are, therefore, directed to improvements in computer-related technology, specifically, by conserving network resources and reducing power consumption of the UE and/or a network entity located within the network.

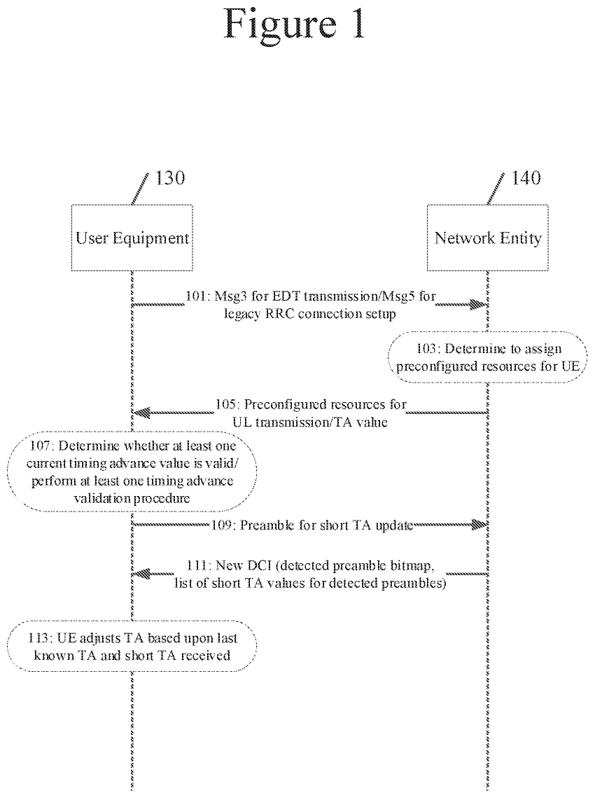

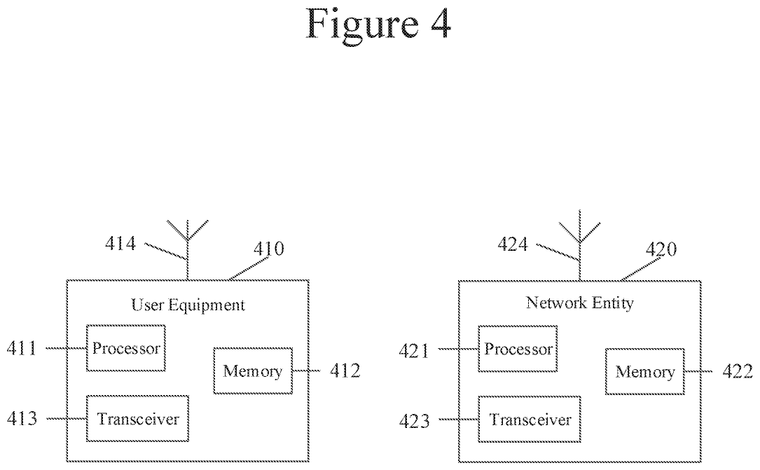

FIG. 1 illustrates an example of a signalling diagram according to some embodiments. User equipment (UE) 110 may be similar to UE 410 in FIG. 4, while network entity (NE) 120 may be similar to NE 420 in FIG. 4. Although only a single UE and NE are illustrated, a communications network may contain one or more of each of these entities. In step 101, UE 130 may transmit at least one Msg3 for (EDT) transmission and/or at least one Msg5 corresponding with at least one legacy radio resource control (RRC) connection setup.

In step 103, NE 140 may determine whether to assign at least one preconfigured resource to UE 130.

In step 105, upon determining to assign at least one preconfigured resource to UE 130, NE 140 transmits at least one indication of at least one resource to UE 130. In some embodiments, NE 140 may also configure at least one single and/or range of preambles that UE 140 may use to trigger at least one timing advance update procedure.

In some embodiments, NE 140 may transmit at least one RRC message to UE 130, which may include one or more parameters for TA validation. For example, at least one RRC message may include at least one TA-validation-required parameter, which may be a binary indication and/or may indicate whether to require UE 130 to validate its TA prior to a next uplink transmission over preconfigured resources. In addition, NE 140 may set this parameter based upon at least one parameter received from a core network as part of UE context creation at the NE 140.

Furthermore, at least one RRC message may include at least one TA-history-based-validation-count. For example, if no timing advance updates for UE 130 are provided for past N uplink transmissions, the TA may be considered as stable and/or TA validation may not be required. In addition, the value may indicate the number of previous attempts to be considered for this validation, where a value of 0 may indicate that history-based validation is not applicable for UE 130.

Furthermore, at least one RRC message may include at least one radio-contention-based-validation-parameter. In some embodiments, at least one radio-contention-based-validation-parameter may be a serving-cell-diff-threshold and/or NCL-diff-threshold, where, if these parameters are configured, and/or depending on the difference on the serving cell RSRP with reference to the RSRP at the time of TA reception, UE 130 may invalidate a current TA value. If NCL-diff-threshold is defined, a decision on TA validation may depend on neighbor-cell RSRP value.

Furthermore, at least one RRC message may include at least one TA-validation-timer, where if this timer is defined, UE 130 may retrieve the latest TA via an short TA update procedure and/or random access procedure at the expiration of this timer. For example, history-based and/or radio condition-based TA validation may indicate at least one valid TA. This timer may be required to ensure that a mechanism over all other mechanisms to maintain the uplink synchronization for idle mode UE 130 to send uplink transmission over preconfigured resources with right TA value.

In some embodiments, in addition to RRC signaling and/or signaling for assigning the preconfigured resource for UE 130, NE 140 may also indicate whether at least one timing advance value given is valid without any associated timer, for example, when the higher layer EPC indicates that UE 130 is stationary, such as when based on at least one subscription service type.

In some embodiments, NE 140 may transmit at least one indication for UE 130 to align the timing advance validity along with a threshold mobility measurement configuration of the UE 130. Furthermore, NE 140 may transmit at least one indication of criteria based on neighbor cell measurements when performing TA validity. For example, if a serving cell strength changes from a previous measurement by a threshold level, UE 130 may trigger at least one TA update procedure.

In some embodiments, NE 140 may transmit at least one indication of criteria based upon previous TA values. For example, if a previous N TA value has been constant, or within a threshold value, UE 130 consider the current TA to be valid and may not trigger a TA update procedure.

In some embodiments, UE 130 may use at least one location measurement to determine TA validity. For example, observed time difference of arrival (OTDOA) position measurements may be used by UE 130 to determine TA validity. For a OTDOA-capable UE, NE 140 may transmit N-PRS/PRS for UE 130 to measurement time-difference of arrivals of multiple NE. Based upon these measurements, UE 130 may determine whether the TA is valid.

In certain embodiments, NE 140 may transmit or configure at least one timing advance validity timer associated with at least one timing advance value. Furthermore, NE 140 may modify the at least one timing advance validity timer associated with the at least one timing advance value estimated for UE 130 based upon previous transmissions. In addition, based upon factors of the timing advance observed by NE 140 over a particular period of time, for example, service history of UE 130 and/or system loading, the at least one timer value may be increased or decreased.

In some embodiments, NE 140 may transmit at least one indication that at least one cyclic prefix (CP) associated with the at least one preconfigured resource based upon a deviation from the TA transmitted to UE 130. Furthermore, NE 140 may determine to alternate the at least one CP between two predetermined values based upon an estimated timing over at least one physical uplink shared channel (PUSCH)/narrowband PUSCH (NPUSCH) associated with the at least one preconfigured resource.

In certain embodiments, NE 140 may assign or configure at least one physical random access channel (PRACH)/narrowband PRACH (NPRACH) with at least one shorter CP and/or fewer symbols and/or shorter preamble. In this case, NE 140 may additionally transmit at least one indication to UE 130 to use the at least one shorter CP NPRACH format. In some embodiments, NE 140 may transmit additional information associated with at least one range of timing advance shift, which is configured to be updated according to the TA update procedure.

In some embodiments, the at least one indication may also include an indication that timing advance validation is not required.

In step 107, UE 130 may determine whether at least one current timing advance value is valid. In addition, UE 130 may, upon determining that the at least one current timing advance value is not valid, performing at least one timing advance validation procedure. In some embodiments, at least one timing advance update procedure is performed when at least one estimated timing advance shift is within at least one threshold, and at least one legacy timing advance procedure is performed when at least one estimated timing advance shift is not within at least one threshold.

In step 109, upon determining that the at least one TA value is invalid and the estimated TA shift or adjustment is within the TA adjustment value corresponding with the TA update procedure, UE 130 may transmit at least one NPRACH preamble associated with or configured by NPRACH configuration via RRC message received from NE 140 and/or an indication of an already known timing advance. In some embodiments, the NPRACH configuration via RRC message received from NE 140 may also include the latest timing advance to UE 130.

In some embodiments, if timing advance validation is required, related assistance information may also be provided to NE 140.

In step 111, NE 140 may transmit at least one TA to UE 130 corresponding to an additional TA shift or adjustment with at least one reference to at least one previous TA value, which may comprise 2-3 bits. In some embodiments, NE 140 may update the at least one TA via at least one bitmap of detected preambles and/or short TA corresponding to at least one detected preamble. When the at least one bitmap of detected preambles and/or short TA corresponding to at least one detected preamble fits within at least one downlink control information (DCI), NE 140 may transmit this information via narrowband physical downlink control channel (NPDCCH)/machine type communication physical downlink control channel (MPDCCH).

In some embodiments, if the detected TA is greater than the shortened value which fits within at least one DCI, NE 140 may transmit at least one indication to UE 130 for UE 130 to check subsequent DCI. For example, one or more code points or values of the at least one shortened TA may be reserved to indicate this check instruction.

In step 113, UE 130 may check at least one NPDSCH/PDSCH resource according to at least one fixed delay from receiving the DCI to receive at least one Msg2 containing at least one complete TA.

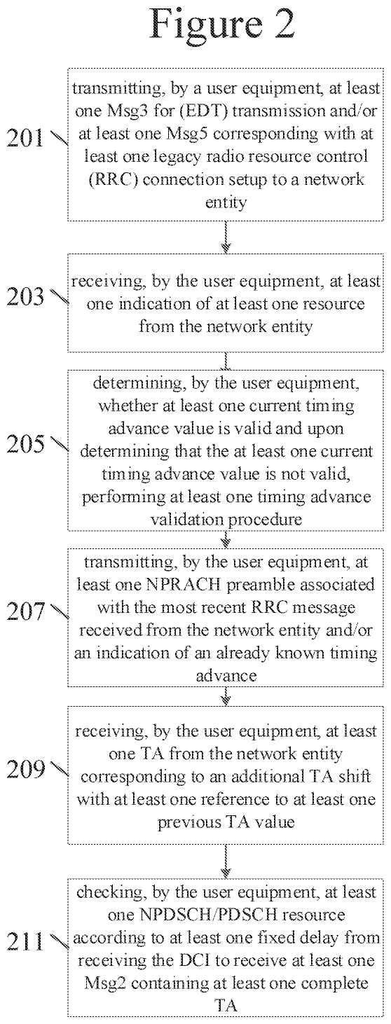

FIG. 2 illustrates an example of a method performed by a user equipment, for example, user equipment 410 in FIG. 4. In step 201, the user equipment may transmit at least one Msg3 for (EDT) transmission and/or at least one Msg5 corresponding with at least one legacy radio resource control (RRC) connection setup to a network entity.

In step 203, the user equipment may receive at least one indication of at least one resource from the network entity. In some embodiments, NE 140 may also configure at least one single and/or range of preambles that UE 140 may use to trigger at least one timing advance update procedure.

In certain embodiments, the user equipment may receive at least one timing advance validity timer associated with at least one timing advance value. Furthermore, the user equipment may modify the at least one timing advance validity timer associated with the at least one timing advance value estimated for the user equipment based upon previous transmissions. In addition, based upon factors of the timing advance observed by the network entity over a particular period of time, for example, service history of the user equipment and/or system loading, the at least one timer value may be increased or decreased.

In some embodiments, the user equipment may receive at least one indication that at least one cyclic prefix (CP) associated with the at least one preconfigured resource based upon a deviation from the TA transmitted from the network entity. Furthermore, the at least one CP may alternate between two predetermined values based upon an estimated timing over at least one physical uplink shared channel (PUSCH)/narrowband PUSCH (NPUSCH) associated with the at least one preconfigured resource.

In certain embodiments, the user equipment may receive an assignment or configuration of at least one physical random access channel (PRACH)/narrowband PRACH (NPRACH) with at least one shorter CP and/or fewer symbols and/or shorter preamble. In this case, the network entity may additionally receive at least one indication from the network entity to use the at least one shorter CP NPRACH format. In some embodiments, the user equipment may receive additional information associated with at least one range of timing advance shift, which is configured to be updated according to the TA update procedure.

In step 205, the user equipment may determine whether at least one current timing advance value is valid. In some embodiments, upon determining that the at least one current timing advance value is not valid, the user equipment may perform at least one timing advance validation procedure. In some embodiments, at least one timing advance update procedure is performed when at least one estimated timing advance shift is within at least one threshold, and at least one legacy timing advance procedure is performed when at least one estimated timing advance shift is not within at least one threshold.

In step 207, upon determining that the at least one TA value is invalid and the estimated TA shift is within the TA value corresponding with the TA update procedure, the user equipment may transmit at least one NPRACH preamble associated with or configured by the NPRACH configuration via RRC message received from the network entity and/or an indication of an already known timing advance. In some embodiments, the NPRACH configuration via RRC message received from the network entity may also include the latest timing advance for the user equipment.

In step 209, the user equipment may receive at least one TA from the network entity corresponding to an additional TA shift or adjustment with at least one reference to at least one previous TA value, which may comprise 2-3 bits. In some embodiments, the user equipment may update the at least one TA via at least one bitmap of detected preambles and/or short TA corresponding to at least one detected preamble. When the at least one bitmap of detected preambles and/or short TA corresponding to at least one detected preamble fits within at least one downlink control information (DCI), the user equipment may receive this information via narrowband physical downlink control channel (NPDCCH)/machine type communication physical downlink control channel (MPDCCH).

In some embodiments, if the detected TA is greater than the shortened value which fits within at least one DCI, the user equipment may receive at least one indication from the network entity for the user equipment to check subsequent DCI. For example, one or more code points or values of the at least one shortened TA may be reserved to indicate this check instruction.

In step 211, the user equipment may check at least one NPDSCH/PDSCH resource according to at least one fixed delay from receiving the DCI to receive at least one Msg2 containing at least one complete TA.

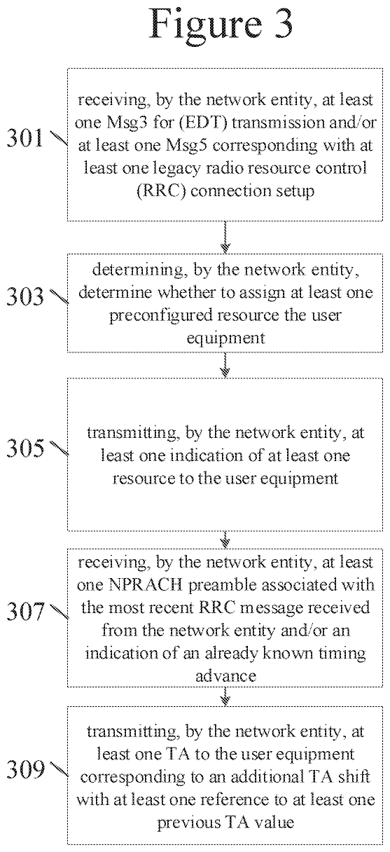

FIG. 3 illustrates an example of a method performed by a network entity, for example, network entity 420 in FIG. 4. In step 301, the network entity may receive at least one Msg3 for (EDT) transmission and/or at least one Msg5 corresponding with at least one legacy radio resource control (RRC) connection setup.

In step 303, the network entity may determine whether to assign at least one preconfigured resource the user equipment. In step 305, upon determining to assign at least one preconfigured resource to the user equipment, the network entity may transmit at least one indication of at least one resource to user equipment. In some embodiments, the network entity may also configure at least one single and/or range of preambles that the user equipment may use to trigger at least one timing advance update procedure.

In certain embodiments, the network entity may transmit at least one timing advance validity timer associated with at least one timing advance value. Furthermore, the network entity may modify the at least one timing advance validity timer associated with the at least one timing advance value estimated for the user equipment based upon previous transmissions. In addition, based upon factors of the timing advance observed by the network entity over a particular period of time, for example, service history of the user equipment and/or system loading, the at least one timer value may be increased or decreased.

In some embodiments, the network entity may transmit at least one indication that at least one cyclic prefix (CP) associated with the at least one preconfigured resource based upon a deviation from the TA transmitted to the user equipment. Furthermore, the network entity may determine to alternate the at least one CP between two predetermined values based upon an estimated timing over at least one physical uplink shared channel (PUSCH)/narrowband PUSCH (NPUSCH) associated with the at least one preconfigured resource.

In certain embodiments, the network entity may assign or configure at least one physical random access channel (PRACH)/narrowband PRACH (NPRACH) with at least one shorter CP and/or fewer symbols and/or shorter preamble. In this case, the network entity may additionally transmit at least one indication to the user equipment to use the at least one shorter CP NPRACH format. In some embodiments, the network entity may transmit additional information associated with at least one range of timing advance shift, which is configured to be updated according to the TA update procedure.

In step 307, the network entity may receive at least one NPRACH preamble associated with or configured by NPRACH configuration via RRC message received from the network entity and/or an indication of an already known timing advance. In some embodiments, the NPRACH configuration via RRC message received from the network entity may also include the latest timing advance from the user equipment.

In step 309, the network entity may transmit at least one TA to the user equipment corresponding to an additional TA shift or adjustment with at least one reference to at least one previous TA value, which may comprise 2-3 bits. In some embodiments, the network entity may update the at least one TA via at least one bitmap of detected preambles and/or short TA corresponding to at least one detected preamble. When the at least one bitmap of detected preambles and/or short TA corresponding to at least one detected preamble fits within at least one downlink control information (DCI), the network entity may transmit this information via narrowband physical downlink control channel (NPDCCH)/machine type communication physical downlink control channel (MPDCCH).

In some embodiments, if the detected TA is greater than the shortened value which fits within at least one DCI, the network entity may transmit at least one indication to the user equipment for the user equipment to check subsequent DCI. For example, one or more code points or values of the at least one shortened TA may be reserved to indicate this check instruction.

FIG. 4 illustrates an example of a system according to certain embodiments. In one embodiment, a system may include multiple devices, such as, for example, user equipment 410 and network entity 420. User equipment 410 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof.

Network entity 420 may be one or more of a base station, such as an evolved node B (eNB) or next generation node B (gNB), a next generation radio access network (NG RAN), a serving gateway, a server, and/or any other access node or combination thereof.

One or more of these devices may include at least one processor, respectively indicated as 411 and 421. At least one memory may be provided in one or more of devices indicated at 412 and 422. The memory may be fixed or removable. The memory may include computer program instructions or computer code contained therein. Processors 411 and 421 and memory 412 and 422 or a subset thereof, may be configured to provide means corresponding to the various blocks of FIGS. 1-3. Although not shown, the devices may also include positioning hardware, such as global positioning system (GPS) or micro electrical mechanical system (MEMS) hardware, which may be used to determine a location of the device. Other sensors are also permitted and may be included to determine location, elevation, orientation, and so forth, such as barometers, compasses, and the like.

As shown in FIG. 4, transceivers 413 and 423 may be provided, and one or more devices may also include at least one antenna, respectively illustrated as 414 and 424. The device may have many antennas, such as an array of antennas configured for multiple input multiple output (MIMO) communications, or multiple antennas for multiple radio access technologies. Other configurations of these devices, for example, may be provided.

Transceivers 413 and 423 may be a transmitter, a receiver, or both a transmitter and a receiver, or a unit or device that may be configured both for transmission and reception.

Processors 411 and 421 may be embodied by any computational or data processing device, such as a central processing unit (CPU), application specific integrated circuit (ASIC), or comparable device. The processors may be implemented as a single controller, or a plurality of controllers or processors.

Memory 412 and 422 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory and which may be processed by the processors may be any suitable form of computer program code, for example, a compiled or interpreted computer program written in any suitable programming language. Memory may be removable or non-removable.

The memory and the computer program instructions may be configured, with the processor for the particular device, to cause a hardware apparatus such as user equipment to perform any of the processes described below (see, for example, FIGS. 1-3). Therefore, in certain embodiments, a non-transitory computer-readable medium may be encoded with computer instructions that, when executed in hardware, perform a process such as one of the processes described herein. Alternatively, certain embodiments may be performed entirely in hardware.

In certain embodiments, an apparatus may include circuitry configured to perform any of the processes or functions illustrated in FIGS. 1-3. For example, circuitry may be hardware-only circuit implementations, such as analog and/or digital circuitry. In another example, circuitry may be a combination of hardware circuits and software, such as a combination of analog and/or digital hardware circuit(s) with software or firmware, and/or any portions of hardware processor(s) with software (including digital signal processor(s)), software, and at least one memory that work together to cause an apparatus to perform various processes or functions. In yet another example, circuitry may be hardware circuit(s) and or processor(s), such as a microprocessor(s) or a portion of a microprocessor(s), that include software, such as firmware for operation. Software in circuitry may not be present when it is not needed for the operation of the hardware.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that certain embodiments discussed above may be practiced with steps in a different order, and/or with hardware elements in configurations which are different than those which are disclosed. Therefore, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### PARTIAL GLOSSARY

3 GPP Third Generation Partnership Project

5G Fifth Generation

CP Cyclic Prefix

DCI Downlink Control Indication

DL Downlink

eNB Evolved Node B

gNB 5G Base Station

LTE Long Term Evolution

MTC Machine Type Communication

NB-IOT Narrowband Internet of Things

NPDCCH Narrowband Physical Data Control Channel

NPDSCH Narrowband Physical Data Shared Channel

NR New Radio

PDSCH Physical Downlink Shared Channel

PDCCH Physical Downlink Control Channel

PGT Preconfigured Grant Transmission

RNTI Radio Network Temporary Identifier

TA Timing Advance

UE User Equipment

UL Uplink

What is claimed is:

1. A method, comprising:
receiving at least one indication of at least one resource from a network entity for uplink transmission;
determining whether at least one current timing advance value is valid; and
performing at least one timing advance update procedure upon determining that the at least one current timing advance value is not valid.

2. The method according to claim 1, further comprising:
performing at least one timing advance update procedure when at least one estimated timing advance shift is within at least one threshold.

3. The method according to claim 1, further comprising:
transmitting at least one preamble with at least one last known timing advance; and
checking for downlink control information comprising at least one correction needed for the at least one current timing advance.

4. The method according to claim 1, wherein the at least one indication of at least one resource is received in response to transmitting of Msg3 for early data transmission or Msg5 which corresponds with radio resource control connection setup.

5. An apparatus, comprising:
at least one memory comprising computer program code;
at least one processor;
wherein the at least one memory and the computer program code are configured, with the at least one processor, to cause the apparatus at least to:
receive at least one indication of at least one resource from a network entity for uplink transmission;
determine whether at least one current timing advance value is valid; and
perform at least one timing advance update procedure upon determining that the at least one current timing advance value is not valid.

6. The apparatus according to claim 5, wherein the at least one timing advance update procedure is performed when at least one estimated timing advance shift is within at least one threshold.

7. The apparatus according to claim 5, wherein the at least one memory and the computer program code are configured, with the at least one processor, to cause the apparatus at least to:
transmit at least one preamble with at least one last known timing advance; and
check for downlink control information comprising at least one correction needed for the at least one current timing advance.

8. The apparatus according to claim 5, wherein the at least one indication of at least one resource is received in response to transmitting of Msg3 for early data transmission or Msg5 which corresponds with radio resource control connection setup.

9. The apparatus according to claim 5, wherein the at least one indication of at least one resource comprises at least one preamble which the apparatus uses to trigger the at least one timing advance update procedure.

10. The apparatus according to claim 5, wherein the at least one memory and the computer program code are configured, with the at least one processor, to cause the apparatus at least to:
detect at least one downlink control indication associated with random access radio network temporary identifier for reception of Msg2.

11. The apparatus according to claim 5, wherein the at least one memory and the computer program code are configured, with the at least one processor, to cause the apparatus at least to:
transmit at least one narrowband physical random access channel preamble configured based upon a last known timing advance associated with narrowband physical random access channel configuration via at least one of radio resource control message, system information, and a radio resource control connection setup message.

12. The apparatus according to claim 5, wherein the at least one memory and the computer program code are configured, with the at least one processor, to cause the apparatus at least to:
transmit at least one preamble with at least one last known timing advance; and
receive at least one timing advance from the network entity corresponding to an additional timing advance shift or adjustment with at least one reference to the at least one last known timing advance value.

13. The apparatus according to claim 5, wherein the at least one indication of at least one resource comprises at least one cyclic prefix indicating a deviation from the at least one current timing advance.

14. The apparatus according to claim 5, wherein the at least one indication of at least one resource comprises determination of timing advance validity based upon mobility measurements.

15. The apparatus according to claim 5, wherein the at least one indication of at least one resource comprises determination of timing advance validity based upon at least one location measurement.

16. The apparatus according to claim 5, wherein the at least one indication of at least one resource comprises parameters for history-based or radio condition-based timing advance validation to validate if the at least one current timing advance value is valid.

17. An apparatus, comprising:
at least one memory comprising computer program code;
at least one processor;
wherein the at least one memory and the computer program code are configured, with the at least one processor, to cause the apparatus at least to:
determine whether to assign at least one preconfigured resource to a user equipment;
transmit at least one indication of at least one resource to the user equipment upon determining to assign at least one preconfigured resource to the user equipment; and
transmit at least one timing advance to the user equipment corresponding to an additional timing advance shift or adjustment with at least one reference to at least one previous timing advance value.

18. The apparatus according to claim 17, wherein the at least one timing advance is transmitted in response to reception of at least one Msg3 for early data transmission or Msg5 which corresponds with radio resource control connection setup.

19. The apparatus according to claim 17, wherein the at least one indication of at least one resource comprises at least one cyclic prefix indicating a deviation from the at least one previous timing advance value.

20. The apparatus according to claim 17, wherein the at least one indication of at least one resource comprises parameters for history-based or radio condition-based timing advance validation to validate current timing advance.
